(19) United States
(12) Patent Application Publication
(10) Pub. No.: US 2006/0025903 A1
(43) Pub. Date: Feb. 2, 2006

(54) Locomotive consist configuration control

(76) Inventor: Ajith Kuttannair Kumar, Erie, PA (US)

Correspondence Address: THE LAW OFFICES OF STEVEN MCHUGH, LLC, 46 WASHINGTON STREET, MIDDLETOWN, CT, 06457, US

(21) Appl. No.: 11/183,369

(22) Filed: Jul. 17, 2005

Related U.S. Application Data
(60) Provisional application No. 60/590,555, filed on Jul. 23, 2004.

(51) Int. Cl. G06F 17/00

(52) U.S. Cl. 701/19

(57) ABSTRACT

A railroad train is provided and includes a first locomotive having a first locomotive electronic processor, a first locomotive communication device in electrical communication with the first locomotive processor, and a first locomotive operator interface in electrical communication with the first locomotive processor. The railroad train also includes a second locomotive having a second locomotive electronic processor, a second locomotive communication device in electrical communication with the second locomotive processor and the first locomotive communication device, a second locomotive sensor in electrical communication with the second locomotive processor for monitoring the operation of the second locomotive and generating signals indicative of the monitored operations, and a second locomotive controller device in electrical communication with the second locomotive processor for controlling the operation of the second locomotive, with the second locomotive processor receiving the signals indicative of the operation of the second locomotive, determining faults in the operation of the second locomotive, and communicating signals indicative of the faults to the second locomotive communication device for transmission to the first locomotive operator interface via the first locomotive communication device and the first locomotive processor, and with the second locomotive controller device being controllable from the first locomotive interface, wherein faults in the operation of the second locomotive are communicated to the first locomotive operator interface and control actions on the operation of the second locomotive in response to the faults may be effected by an operator on the first locomotive.

### RELATED APPLICATIONS

This application claims priority of U.S. Provisional Patent Application Ser. No. 60/590,555 filed Jul. 23, 2004, the contents of which are incorporated herein by reference in its entirety.

### FIELD OF THE INVENTION

The present invention relates generally to communications between locomotives and, more particularly, to communication between locomotives in a consist operating in extreme environmental conditions.

### BACKGROUND OF THE INVENTION

Locomotives that are used for heavy haul applications tend to experience extreme environmental conditions, including low/high temperatures and/or high altitudes. In some situations, many locomotives are typically connected together to be able to pull heavy trains. These locomotives are interconnected electrically by MU trainlines so that an operator in the front locomotive can control the operation of the trailing locomotives. For example, freight trains are often hauled by multiple locomotive ensembles (“consists”) placed together at the front or rear of the train or dispersed among the freight cars. A single crew at the front of the train coordinates all of the locomotive throttles and brake commands via a connection called the multiple unit line (“MU-line”) that runs among the locomotives. Another example is, if the front, or lead, locomotive is in dynamic braking operation at a specified brake level (controlled by an operator request), then all of the locomotives in the consist are also operating in dynamic braking operation at the same specified level. As such, it should be appreciated that there may be multiple consists in a train and that these consists may be set up such that all of the locomotives in each consist act in unison.

In addition to this kind of information, trainline modems (and other communication systems, like RF) are used to send other types of information regarding the operation of the trailing locomotives to the front locomotive (where the operator is typically located), including, but not limited to, operating mode, tractive/braking effort, horsepower, engine speed, motoring/braking failure, engine failure, battery charger failure and locked axle failure. Referring to FIG. 1, one example of a locomotive consist screen display 100, in accordance with the prior art, is shown and may include several indications of fault occurrences. Currently, when an operator receives a fault occurrence indication, he/she has to travel back to the trailing locomotives to obtain further information regarding the fault, such as the fault code and/or the fault data, or at this point he/she can reset the fault, retry or reconfigure the locomotive (for example, cut out a traction motor).

One disadvantage to this configuration is that when these locomotives are operating at higher altitudes it is difficult, and in some cases dangerous, for the operator to get down from the leading, or front, locomotive and get on a trailing locomotive, since only the operator cab in the front locomotive is provided with an oxygen supply and the locomotives may be covered in snow and/or ice. One possible way to address this problem might be to have the operator carry a portable oxygen tank when he/she is traveling between locomotives. Unfortunately however, these tanks can be cumbersome and heavy and in some situations, carrying these tanks can increase the likely hood of injury and/or death due to a potential buildup of ice and/or snow. Another disadvantage involves stopping the train at higher altitudes. Since it is not advisable to travel between the locomotives while the train is moving, in most cases the train must be stopped and since travel at higher altitudes typically includes traversing steep grades which may have snow and ice on the tracks, restarting the train tends to be difficult and may cause delays along the railroad line. Still another disadvantage with traveling between locomotives while the train is moving involves the operational disadvantage of the operator not being able to watch the track. As such, if there was debris, such as snow, rocks and/or trees or if there were an animal on the track, the operator would be unable to react and thus, would not be able to respond or even be aware of a dangerous situation until it is too late. Moreover, there may be other terrains, such as tunnels and very steep grades, and climate conditions, such as sub-zero temperatures and storms, where traveling between locomotives is not desirable, especially if the locomotive units are spaced a large distance apart from each other.

### SUMMARY OF THE INVENTION

A railroad train is provided, wherein the railroad train includes a first locomotive having a first locomotive electronic processor, a first locomotive communication device in electrical communication with the first locomotive processor, and a first locomotive operator interface in electrical communication with the first locomotive processor. The railroad train also includes a second locomotive having a second locomotive electronic processor, a second locomotive communication device in electrical communication with the second locomotive processor and in communication with the first locomotive communication device, a second locomotive sensor in electrical communication with the second locomotive processor for monitoring operation of the second locomotive and generating signals indicative of the monitored operations, and a second locomotive controller device in electrical communication with the second locomotive processor for controlling the operation of the second locomotive, with the second locomotive processor receiving the signals indicative of the operation of the second locomotive, determining faults in the operation of the second locomotive, and communicating signals indicative of the faults to the second locomotive communication device for transmission to the first locomotive operator interface via the first locomotive communication device and the first locomotive processor, and with the second locomotive controller device being controllable from the first locomotive interface via the first and second locomotive processors and the first and second locomotive communication devices, wherein faults in the operation of the second locomotive are communicated to the first locomotive operator interface and control actions on the operation of the second locomotive in response to the faults may be effected by an operator on the first locomotive.

A communication/control system for a railroad train having a first locomotive and a second locomotive is provided and includes a first locomotive electronic processor, a first locomotive communication device in electrical communication with the first locomotive processor, and a first locomotive operator interface in electrical communication with the first locomotive processor. The communication/control system also includes a second locomotive electronic processor, a second locomotive communication device in electrical communication with the second locomotive processor and in communication with the first locomotive communication device, a second locomotive sensor in electrical communication with the second locomotive processor for monitoring operation of the second locomotive and generating signals indicative of the monitored operations, and a second locomotive controller device in electrical communication with the second locomotive processor for controlling the operation of the second locomotive, with the second locomotive processor receiving the signals indicative of the operation of the second locomotive, determining faults in the operation of the second locomotive, and communicating signals indicative of the faults to the second locomotive communication device for transmission to the first locomotive operator interface via the first locomotive communication device and the first locomotive processor, and with the second locomotive controller device being controllable from the first locomotive interface via the first and second locomotive processors and the first and second locomotive communication devices, wherein faults in the operation of the second locomotive are communicated to the first locomotive operator interface and control actions on the operation of the second locomotive in response to the faults may be effected by an operator on the first locomotive.

A method for ensuring control of a locomotive within a locomotive consist, wherein the locomotive consist includes a first locomotive processor, a second locomotive processor and a second locomotive controller device communicated with the second locomotive processor, wherein the first locomotive processor is communicated with the second locomotive processor and wherein the second locomotive processor is configurable to allow the first locomotive processor to control the second locomotive controller device is provided, wherein the method includes monitoring the second locomotive controller device to determine whether a fault condition of the second locomotive controller device has occurred and if a fault condition has occurred, communicating the fault condition to an operator of the locomotive consist and operating the first locomotive processor to control the second locomotive controller device.

### BRIEF DESCRIPTION OF THE FIGURES

The foregoing and other features and advantages of the present invention will be more fully understood from the following detailed description of illustrative embodiments, taken in conjunction with the accompanying drawings in which like elements are numbered alike in the several Figures:

FIG. 1 is a screen capture of a Consist Monitor Screen, in accordance with the prior art;

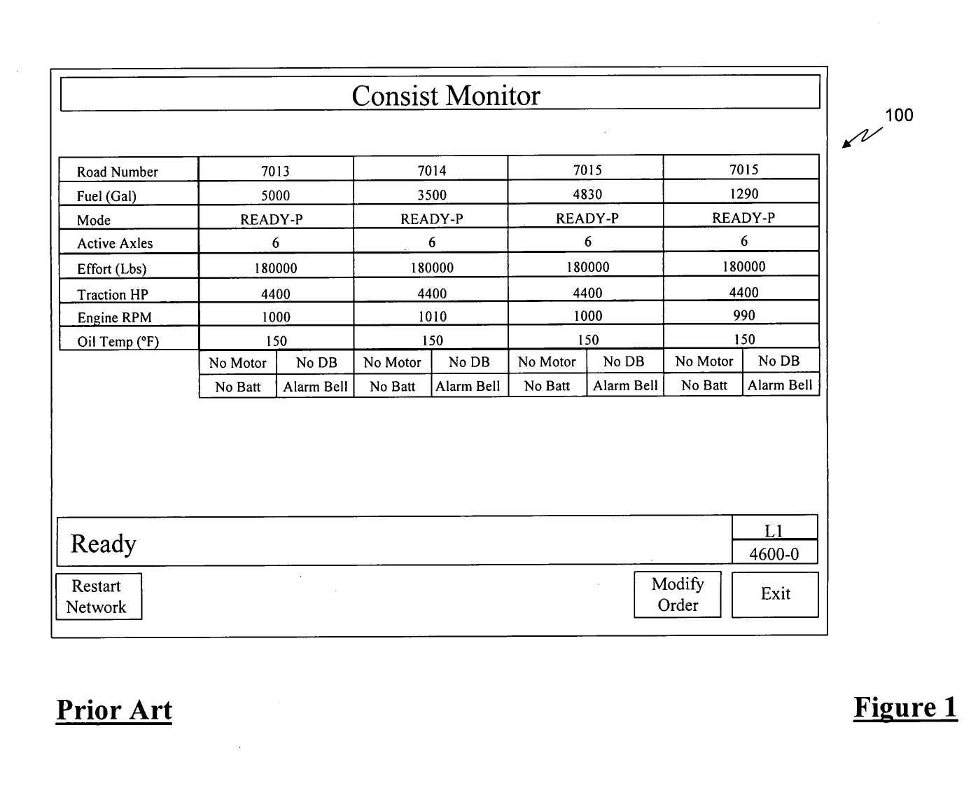

FIG. 2 is a block diagram showing a first embodiment of a communication connection between locomotives in a locomotive consist;

FIG. 3 is a screen capture of a Consist Monitor Screen for the locomotive consist of FIG. 2;

FIG. 4 is a block diagram showing a second embodiment of a communication connection between locomotives in the locomotive consist of FIG. 2;

FIG. 5 is a screen capture of a Consist Monitor Screen for the locomotive consist of FIG. 4;

FIG. 6 is a block diagram showing a third embodiment of a communication connection between locomotives in a locomotive consist;

FIG. 7 is a screen capture of a Consist Monitor Screen for the locomotive consist of FIG. 6; and

FIG. 8 is a block diagram illustrating a method for ensuring control of a locomotive within a locomotive consist.

### DETAILED DESCRIPTION OF THE INVENTION

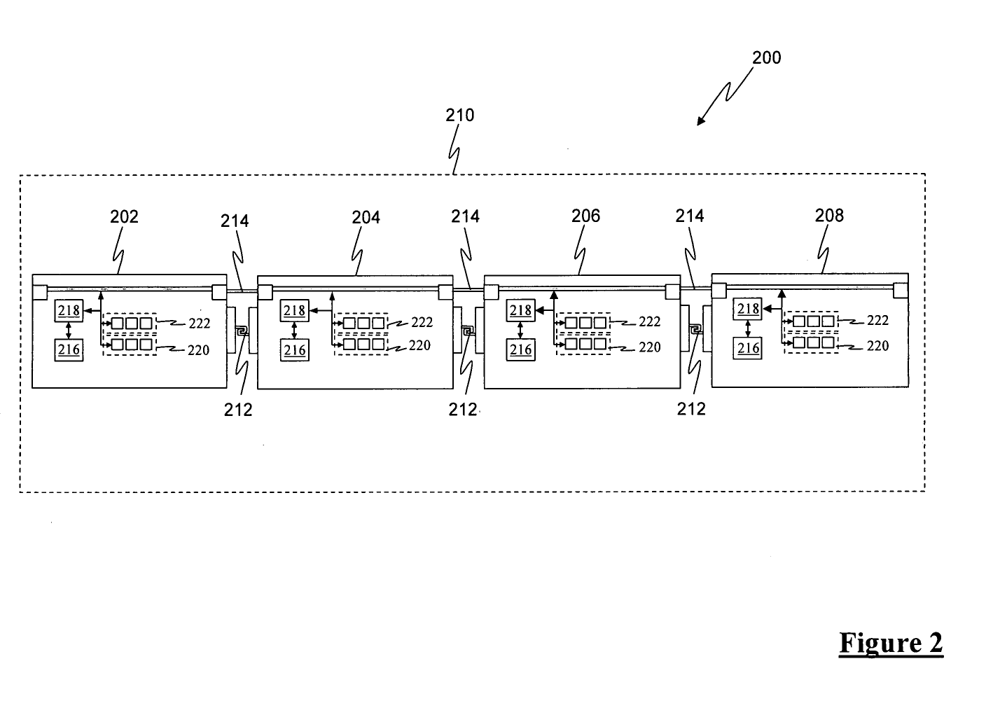

Referring to FIG. 2, a schematic block diagram illustrating one embodiment of a locomotive consist system 200 is shown and includes a first locomotive 202, a second locomotive 204, a third locomotive 206 and a fourth locomotive 208 connected in a consist 210 via a plurality of connection devices, such as a plurality of mechanical connection devices 212. Additionally, each of the first locomotive 202, the second locomotive 204, the third locomotive 206 and the fourth locomotive 208 are communicated with each other via a Multiple Unit (MU) line 214. Each locomotive may include a processing device 216, an input/output device 218, at least one controller device 220 and at least one sensing device 222, wherein the processing device 216, the input/output device 218, the at least one controller device 220 and the at least one sensing device 222 may be communicated with each other. Moreover, the processing device 216, the input/output device 218 and the at least one controller device 220 on each of the locomotives 202, 204, 206, 208 are further communicated with the remaining locomotives 202, 204, 206, 208 via the MU line 214 such that the processing device 216, the input/output device 218, the at least one controller device 220 and the at least one sensor device 222 on at least one of the locomotives 202, 204, 206, 208 is capable of establishing communication with the processing device 216, the input/output device 218, the at least one controller device 220 and the at least one sensor device 222 on at least one of the other locomotives 202, 204, 206, 208. It should be appreciated that although the MU Line 214 is shown as being a hardwired connection, the MU Line 214 may utilize a wireless communications link, such as I/R, RF and Satellite.

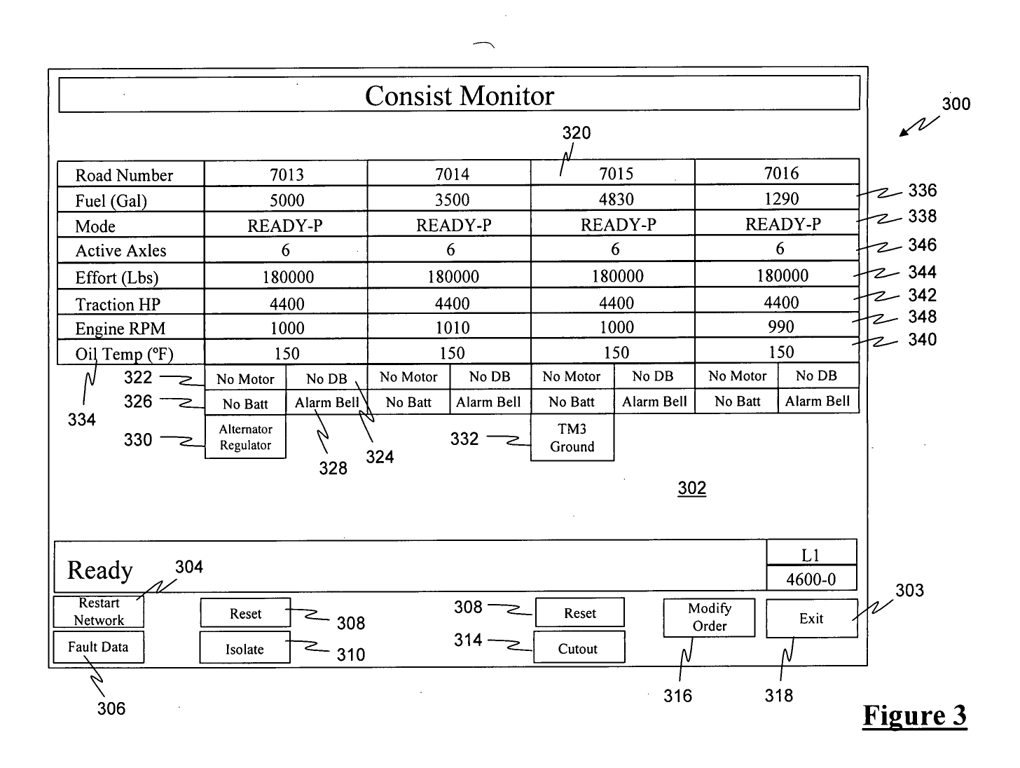

In the configuration shown in FIG. 2, as the consist 210 is operating, sensor data is being generated by the at least one sensor device 222 on each of the locomotives 204, 206, 208 and the generated data from the second locomotive 204, the third locomotive 206 and the fourth locomotive 208 is being communicated to the first locomotive 202 via the MU line 214, wherein the data may be displayed on the input/output device 218 of the first locomotive 202 to an operator. Referring to FIG. 3, one embodiment of a sensor display 300 on the input/output device 218 is shown and may include a Touch Menu Item (TMI) (softkey) screen 302 and/or a keyboard for command and/or data entry from the operator. The TMI screen 302 may include a plurality of software configurable input devices 303 such as a Network Restart switch 304 which is a request that the network information be resent to the sensor display 300, a Fault Data switch 306 which is a request that all or some of the data that was generated at the time of the failure, which may or may not include fault data, be sent to the sensor display 300, a Reset switch 308 which is a request to reset the faulted equipment, an Isolation switch 310 which is a request to isolate the faulted equipment and/or locomotive from the rest of the system, a Cutout switch 314 which is a request to cutout the faulted equipment from the rest of the system, an Order Modification switch 316 and an Exit switch 318.

Upon a condition that requires attention from the locomotive operator, such as a fault condition, an indication will be communicated to the operator that tells the operator that a condition has occurred that needs his/her attention and a condition indicator, which may be specific and/or general, will be displayed on the input/output device 218, wherein the condition indicator may be in the form of a plurality of software configurable display indicators 320 and switches, which may be specific and/or general. It should be appreciated that the plurality of software configurable display indicators 320 may include, but not be limited to, a No Motor indicator 322, a No DB (Dynamic Braking) indicator 324, a No Batt indicator 326, an Alarm Bell indicator 328, an alternator regulator fault indicator 330 and a TM Ground Fault indicator 332. Additionally, the plurality of software configurable display indicators 320 may also include a plurality of configurable operational performance indicators 334, such as fuel level 336, operational mode 338, Oil Temperature 340, traction HP 342, Effort 344, number of active axles 346 and Engine RPM 348.

This should allow the locomotive consist system 200 to inform the operator of a active fault or problem and a suggested course of action (from a stored databank and/or from personnel at a remote facility) and/or the operator may access a fault data display to link directly with and/or to obtain help from central service personnel. If the operator requires more information about the condition, he/she may operate the input/output device 218 to obtain more data which may be transmitted via the MU line 214 to the processing device 216. Once the operator has obtained the desired information regarding the fault indication, the operator may send commands to the trailing locomotive(s), i.e. the second locomotive 204, third locomotive 206 and/or the fourth locomotive 208, responsive to the indicated fault condition. These commands may include, but may not be limited to, a fault reset command, a fault reevaluation command, a reconfiguration command to reconfigure the locomotives (individually or together) and a fault data display command. This would allow an operator in the lead locomotive to obtain critical/non-critical information and to control the operation of the remaining locomotives 202, 204, 206, 208 within the consist 210.

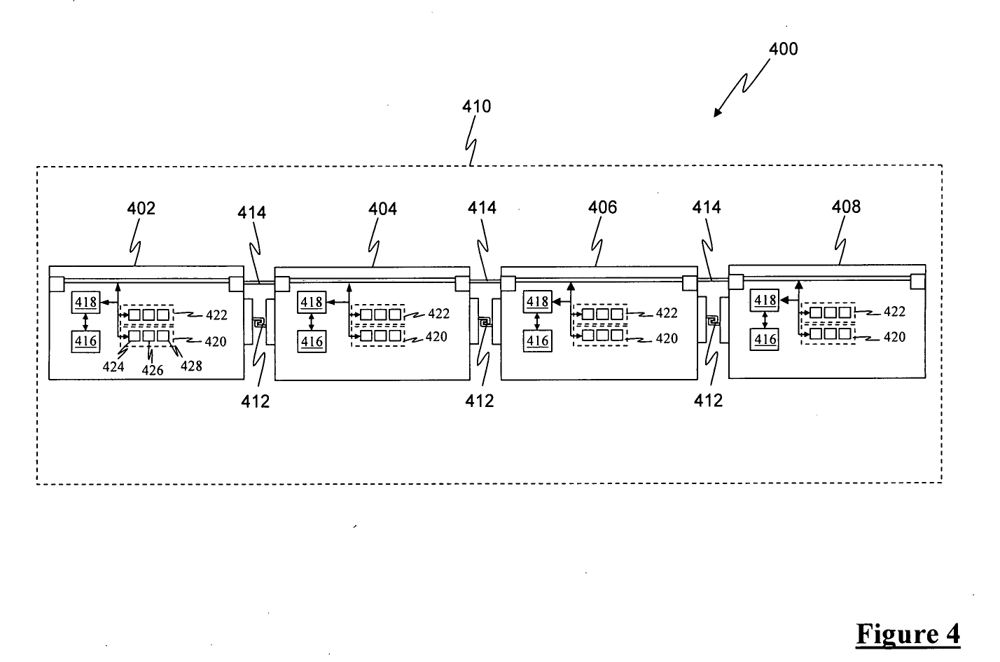

It should be appreciated that the following scenarios are only meant to illustrate the invention and thus are not meant to limit this invention to only these scenarios. As such, this invention is intended to be applicable to any scenario that may require action by the operator of the train. Referring to FIG. 4, consider the situation where there are four (4) locomotives operating in a locomotive consist system 400. A schematic block diagram illustrating the locomotive consist system 400 is shown and includes a first locomotive 402, a second locomotive 404, a third locomotive 406 and a fourth locomotive 408 connected in a consist 410 via a plurality of connection devices, such as a plurality of mechanical connection devices 412. Additionally, each of the first locomotive 402, the second locomotive 404, the third locomotive 406 and the fourth locomotive 408 may be communicated with each other via a Multiple Unit (MU) line 414. As shown, each of the locomotives 402, 404, 406, 408 may include a processing device 416, an input/output device 418, at least one controller device 420 and at least one sensing device 422, wherein the processing device 416, the input/output device 418, the at least one controller device 420 and the at least one sensing device 422 are communicated with each other. It should be appreciated that the at least one controller device 420 may include at least one of a traction alternator regulator 424, a traction motor 426 and a dynamic braking system 428, an alternator device, a circuit breaker device, a switching device, a power electronics device, a blower, a fan and an electrical contactor. Moreover, the processing device 416, the input/output device 418 and the at least one controller device 420 on each of the locomotives 402, 404, 406, 408 are further communicated with the remaining locomotives 402, 404, 406, 408 via the MU line 414 such that the processing device 416, the input/output device 418, the at least one controller device 420 and the at least one sensor device 422 on at least one of the locomotives 402, 404, 406, 408 is capable of establishing communication with and control of the processing device 416, the input/output device 418, the at least one controller device 420 and the at least one sensor device 422 on at least one of the other locomotives 402, 404, 406, 408, either separately and/or collectively.

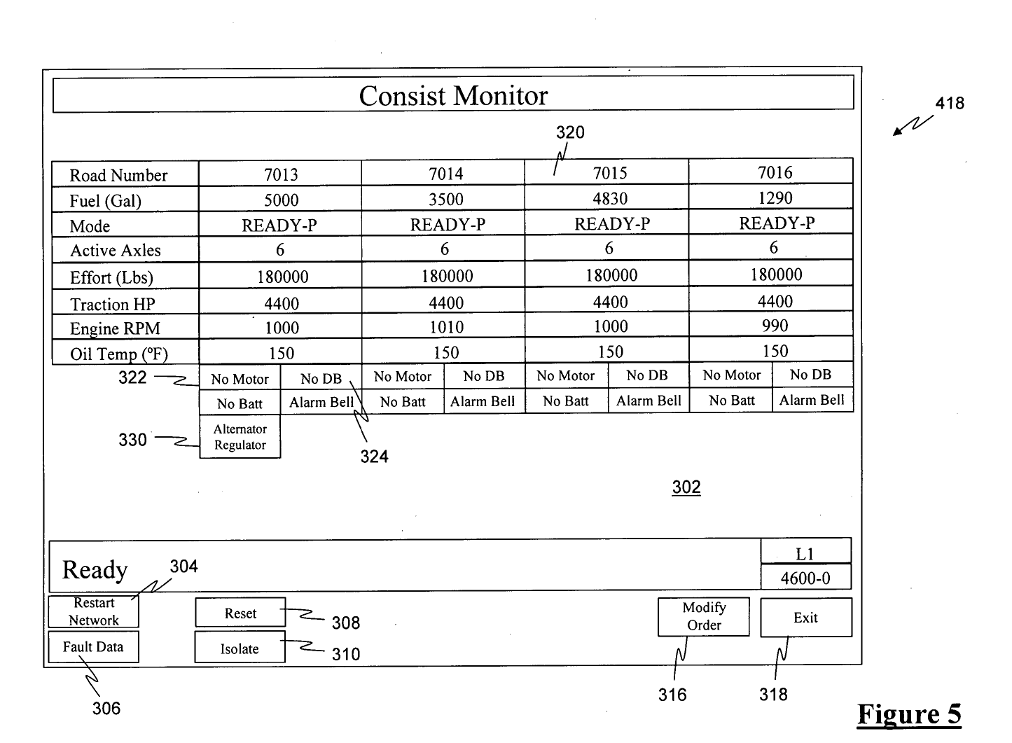

Referring to FIG. 4 and FIG. 5, consider a first situation where a failure of one of the controller devices 420, such as the traction alternator regulator 424, occurs on the first locomotive 402. In this case, the following scenario is likely. As the consist 410 is operating, sensor data is being generated and communicated from the second locomotive 404, the third locomotive 406 and the fourth locomotive 408 to the first locomotive 402 and is displayed to the operator on the input/output device 418 of the first locomotive 402. Upon a failure of the alternator regulator 424 on the first locomotive 402, a failure indication of the alternator regulator 424 is communicated to the operator via the TMI softkey screen 302 on the input/output device 418, as indicated by the highlighted “Alternator Regulator” softkey 330. Additionally, because a failure of the alternator regulator 424 will most likely result in a motoring operation failure and a braking operation failure as well, the operator is also informed of a motoring operation failure and a braking operation failure, as indicated by the highlighted “No Motor” softkey 322 and “No DB” softkey 324, respectively. In this case, the operator has the option of isolating the first locomotive 402 from the rest of the consist 410 via an isolate softkey switch 310 or the operator may try to reset the fault via a reset softkey switch 308. Additionally, the operator may attempt to restart the system network via a reset network softkey switch 304 or the operator may request fault data via a fault data softkey switch 306. As such, the operator may be informed of the situation and may perform the appropriate actions without leaving the lead locomotive. The operator may then modify instructions given to the consist system 400 or exit the consist monitor screen 302 via a Modify Order softkey switch 316 and an Exit softkey switch 318, respectively.

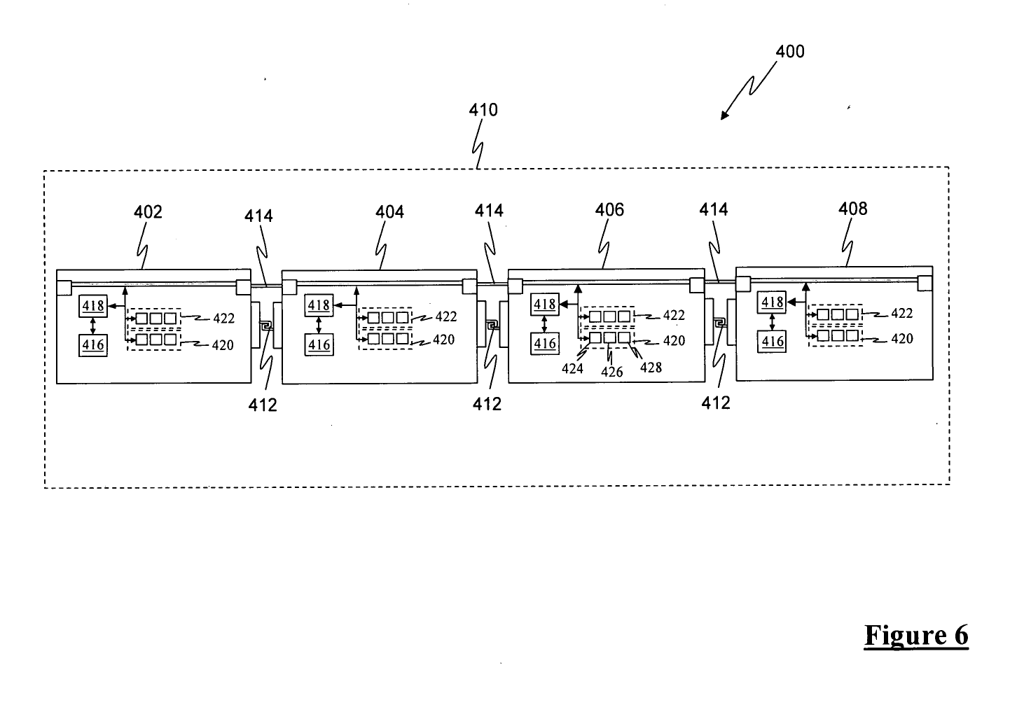

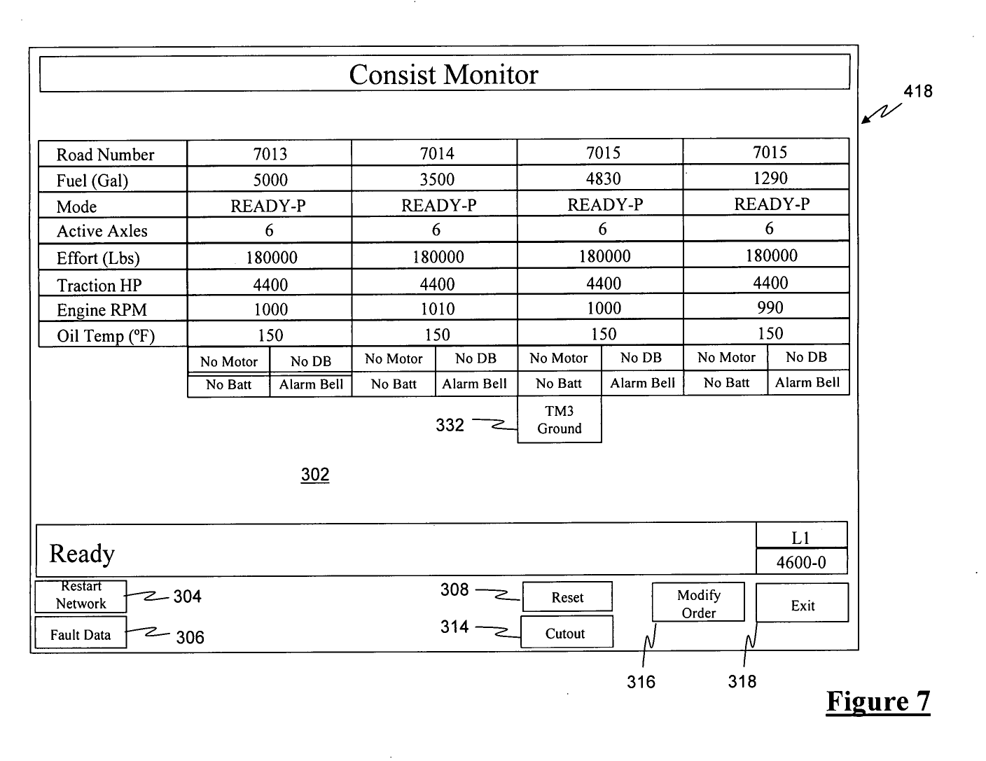

Referring to FIG. 6 and FIG. 7, consider a second situation where there are four (4) locomotives operating in the locomotive consist 410 and a ground fault occurs involving the third traction motor 426 on the third locomotive 406. As above, the operator in the lead locomotive may be informed of this condition via the input/output device 418, wherein the failure of the third traction motor 426 is communicated to the operator via a highlighted “TM3 Ground” softkey indicator 332 on the input/output device 418. In this case, the operator has the option to cut out the traction motor 426 (i.e. shut the motor down) via a “Cutout” softkey 314 or the operator has the option to try to reset the ground fault via the “Reset” softkey 308. As above, the operator may attempt to restart the system network via a Reset Network softkey switch 304 or the operator may request fault data via a Fault Data softkey switch 306 allowing the operator to be informed of and control the situation without leaving the lead locomotive. The operator may then modify instructions given to the consist system 400 or exit the consist monitor screen 302 via a Modify Order softkey switch 316 and an Exit softkey switch 318, respectively. Additionally, it should be appreciated that fault data may be communicated to a storage database and/or a remote receiving center which will log the data for future repair. For example, in the ground fault example above, the fault information may be sent to the next destination of the locomotive, either at the command of the operator or automatically, so that by the time the locomotive arrives at its destination, the parts and/or personnel will be ready to begin work on the motor to correct the fault condition. This would allow for a reduction in the amount of downtime of the locomotive and ultimately would translate into fewer and/or shorter delays.

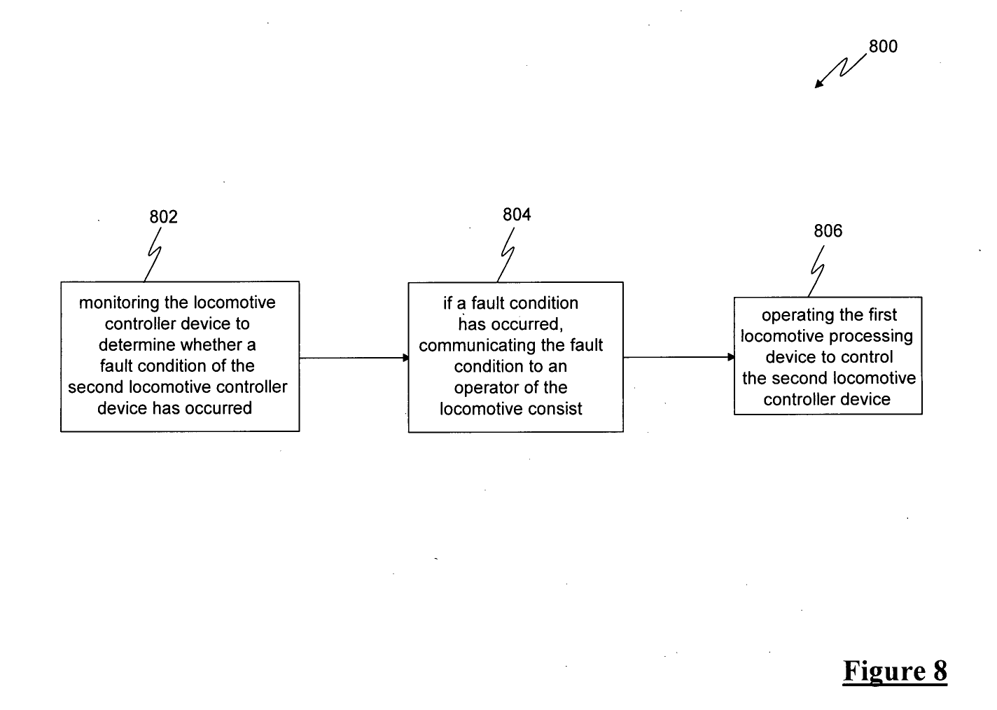

Referring to FIG. 8, a block diagram illustrating a method 800 for ensuring control of a locomotive 202, 204, 206, 208, 402, 404, 406, 408 within a locomotive consist 210, 410 is provided. The locomotive consist 210, 410 may include a first locomotive 202, 402 and a second locomotive 204, 404, wherein the first locomotive 202, 402 includes a first locomotive display device 218, 418 and a first locomotive processing device 216, 416, and wherein the second locomotive 204, 404 includes a second locomotive processing device 216, 416 and a second locomotive controller device 220, 420 communicated with the second locomotive processing device 216, 416. Additionally, the first locomotive processing device 216, 416 is communicated with the second locomotive processing device 216, 416 via a Multiple Unit line 214, 414 and the second locomotive processing device 216, 416 is configurable to allow the first locomotive processing device 216, 416 to control the locomotive controller device 220, 420. The method 800 includes monitoring the locomotive controller device 220, 420 to determine whether a fault condition of the second locomotive controller device 220, 420 has occurred, as shown in operational block 802. If a fault condition has occurred, then the method 800 includes communicating the fault condition to an operator of the locomotive consist 208, 400, as shown in operational block 804 and operating the first locomotive processing device 216, 416 to control the second locomotive controller device 220, 420, as shown in operational block 806, such that the first locomotive processing device 216, 416 is able to control the second locomotive controller device 220, 420 from the first locomotive 202, 402.

Moreover, other features and functions suitable to the desired end purpose may be included, such as a self testing, diagnostic and/or monitoring capability. This would allow the operator the ability to initiate a self-test routine for preventive maintenance and or fault isolation and/or detection. Moreover, the diagnostic capability may be used for trouble shooting and/or fault repair and/or reconfiguration, such as isolation and/or cutout. It should be appreciated that the self testing, diagnostic and/or monitoring capabilities may be implemented by the on-site operator or by a remote operator prior to a fault occurrence, immediately following a fault occurrence and/or after fault data has been received. Additionally, each of the locomotives in the consist 210, 410 may be tested as a group or individually in any order. This would allow an on-site operator and/or a remote operator to perform function and safety tests prior to each departure.

Additionally, it should be appreciated that the locomotive consist system 200, 400 may be used to implement operations not currently under control of a control system. For example, the traction alternator field cutout is currently controlled by a circuit breaker which requires that the physical connection be broken manually. It is contemplated that these types of system and/or connections may be controlled via a configurable softkey (i.e. software) switch 303 from the display device 218, 418. Additionally, it is contemplated that the above may be implemented by an on-site operator who may be assisted by remote experts that is in communication with the locomotive consist system 200, 400 via a wireless communications system, such as Satellite, RF and IR. Furthermore, the locomotive consist system 200, 400 may also be used to monitor the MU line 214, 414 to detect if a fault occurrence is due to the MU cables/connection or due to the actual unit indicating a fault occurrence.

It should be appreciated that all communications may be conducted via a hardwired system or by a wireless system, such as Satellite, Radio Frequency, Infra Red etc. Moreover, in some situations, such as incapacity of the crew, a wireless system may allow a central service office to assume control of the consist 210, 410 and/or specific locomotives 202, 204, 206, 208, 402, 404, 406, 408 and to operate the consist 210, 410 and/or specific locomotives 202, 204, 206, 208, 402, 404, 406, 408 remotely, collectively or individually. Thus, all of the information and control available to an operator on the locomotive would be accessible by personnel at the central service (dispatch) office. Additionally, since the amount of information normally passed between locomotive is relatively small, the bandwidth of the communication channel to carry this information may be correspondingly small. However, normal data transmission may be limited to allow more condition information (such as fault/health information) and/or associated commands to be communicated. It should also be appreciated that because all of the locomotives are communicated with each other, the crew may controllably switch control from one locomotive to another in the consist 210, 410. This may be useful if the lead locomotive is not operating correctly and must be shut down. In this situation, operators may switch control of the lead locomotive in the consist 210, 410 to one of the remaining locomotives 202, 204, 206, 208, 402, 404, 406, 408, such as second locomotive 204, 404, third locomotive 206, 406 or the fourth locomotive 208, 408. For example, if a traction motor 426 has failed, then the operator could cut out the traction motor 426 and proceed with a degraded mode of operation. Another example involves major equipment damage of MIS operation, the unit could be commanded to isolate or standby mode or to ignore throttle commands so that the rest of the consist 210, 410 could proceed. Another example would be to limit the total tractive/braking effort produced during certain periods of operation for the safe handling of the train.

It is contemplated that the at least one controller device 216, 416 may include any number and/or type of controller device(s) suitable to the desired end purpose, including but not limited to a throttle control, an environmental control and/or a brake control. Moreover, at least one sensor device 222, 422 may include any number and/or type of sensor device(s) suitable to the desired end purpose, including but not limited to a fault sensor device, a traction motor sensing device and/or a cab environment sensing device. Furthermore, in current systems only data was flowing from a remote locomotive to an operator. However, in the disclosed embodiments as described herein, more information flow, information flows between a remote locomotive and an operator and the operator may send commands to the remote locomotive to assume additional operational actions, such as diagnostics, performance, reconfiguration, etc.

As described above, the method 800 of FIG. 8, in whole or in part, may be embodied in the form of computer-implemented processes and apparatuses for practicing those processes. The method 800 of FIG. 8, in whole or in part, may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) may be updated to implement the method 800 of FIG. 8, in whole or in part. Also as described above, the method 800 of FIG. 8, in whole or in part, may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments may configure the microprocessor to create specific logic circuits.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A railroad train, comprising:
a first locomotive, wherein said first locomotive includes a first locomotive electronic processor, a first locomotive communication device in electrical communication with the first locomotive processor, and a first locomotive operator interface in electrical communication with the first locomotive processor; and
a second locomotive, wherein said second locomotive includes a second locomotive electronic processor, a second locomotive communication device in electrical communication with the second locomotive processor and in communication with the first locomotive communication device, a second locomotive sensor in electrical communication with the second locomotive processor for monitoring operation of the second locomotive and generating signals indicative of the monitored operations, and a second locomotive controller device in electrical communication with the second locomotive processor for controlling the operation of the second locomotive,
with the second locomotive processor receiving the signals indicative of the operation of the second locomotive, determining faults in the operation of the second locomotive, and communicating signals indicative of the faults to the second locomotive communication device for transmission to the first locomotive operator interface via the first locomotive communication device and the first locomotive processor, and with the second locomotive controller device being controllable from the first locomotive interface via the first and second locomotive processors and the first and second locomotive communication devices,
wherein faults in the operation of the second locomotive are communicated to the first locomotive operator interface and control actions on the operation of the second locomotive in response to the faults may be effected by an operator on the first locomotive.

2. The railroad train of claim 1, wherein the first and second locomotives are mechanically interconnected to form a locomotive consist and the first and second locomotive communication devices communicate via a hardwire trainline extending between the locomotives.

3. The railroad train of claim 1, wherein the first and second locomotive communication devices communicate with each other via a wireless communication link.

4. The railroad train of claim 3, wherein the first and second locomotives are at spaced locations along the train and are separated by at least one railcar.

5. The railroad train of claim 1, wherein said locomotive controller device controls at least one of a traction motor, an alternator device, a circuit breaker device, a switching device, a power electronics device, a blower, a fan and an electrical contactor.

6. The railroad train of claim 1, wherein the first locomotive operator interface includes inputs for controlling isolation of a traction motor on the second locomotive, engine reset on the second locomotive, engine cutout on the second locomotive and traction motor cutout on the second locomotive.

7. The railroad train of claim 1, wherein the first locomotive interface includes inputs for initiating tests of said second locomotive controller device.

8. The railroad train of claim 1, wherein at least one of said first locomotive communication device and said second locomotive is in communication with a wireless, portable, handheld device.

9. The railroad train of claim 1, wherein at least one of said first locomotive processor and said second locomotive processor is in communication with a wireless transceiver at a remote location.

10. The railroad train of claim 9, wherein at least one of said first locomotive processor and said second locomotive processor is controlled from said remote location to allow said remote location to control operation of the railroad train.

11. The railroad train of claim 10, wherein said remote location is a central dispatch office.

12. A communication/control system for a railroad train having a first locomotive and a second locomotive, the communication/control system comprising:
a first locomotive electronic processor, a first locomotive communication device in electrical communication with the first locomotive processor, and a first locomotive operator interface in electrical communication with the first locomotive processor; and
a second locomotive electronic processor, a second locomotive communication device in electrical communication with the second locomotive processor and in communication with the first locomotive communication device, a second locomotive sensor in electrical communication with the second locomotive processor for monitoring operation of the second locomotive and generating signals indicative of the monitored operations, and a second locomotive controller device in electrical communication with the second locomotive processor for controlling the operation of the second locomotive,
with the second locomotive processor receiving the signals indicative of the operation of the second locomotive, determining faults in the operation of the second locomotive, and communicating signals indicative of the faults to the second locomotive communication device for transmission to the first locomotive operator interface via the first locomotive communication device and the first locomotive processor, and with the second locomotive controller device being controllable from the first locomotive interface via the first and second locomotive processors and the first and second locomotive communication devices,
wherein faults in the operation of the second locomotive are communicated to the first locomotive operator interface and control actions on the operation of the second locomotive in response to the faults may be effected by an operator on the first locomotive.

13. The communication/control system of claim 12, wherein the first and second locomotives are mechanically interconnected to form a locomotive consist and the first and second locomotive communication devices communicate via a hardwire trainline extending between the locomotives.

14. The communication/control system of claim 12, wherein the first and second locomotive communication devices communicate with each other via a wireless communication link.

15. The communication/control system of claim 14, wherein the first and second locomotives are at spaced locations along the train and are separated by at least one railcar.

16. The communication/control system of claim 12, wherein said locomotive controller device controls at least one of a traction motor, an alternator device, a circuit breaker device, a switching device, a power electronics device, a blower, a fan, an electrical contactor and a second locomotive traction motor.

17. The communication/control system of claim 12, wherein the first locomotive operator interface includes inputs for controlling isolation of traction motors on the second locomotive, engine reset on the second locomotive, engine cutout on the second locomotive and engine cutout reset on the second locomotive.

18. The communication/control system of claim 12, wherein the first locomotive interface includes inputs for initiating tests of said second locomotive controller device.

19. The communication/control system of claim 12, wherein at least one of said first locomotive communication device and said second locomotive is in communication with a wireless, portable, handheld device.

20. The communication/control system of claim 12, wherein at least one of said first locomotive processor and said second locomotive processor is in communication with a wireless transceiver at a remote location.

21. The communication/control system of claim 20, wherein at least one of said first locomotive processor and said second locomotive processor is controlled from said remote location to allow said remote location to control operation of the railroad train.

22. The communication/control system of claim 21, wherein said remote location is a central dispatch office.

23. A method for ensuring control of a locomotive within a locomotive consist, wherein the locomotive consist includes a first locomotive processor, a second locomotive processor and a second locomotive controller device communicated with the second locomotive processor, wherein the first locomotive processor is communicated with the second locomotive processor and wherein the second locomotive processor is configurable to allow the first locomotive processor to control the second locomotive controller device, the method comprising:
monitoring the second locomotive controller device to determine whether a fault condition of the second locomotive controller device has occurred;
if a fault condition has occurred, communicating said fault condition to an operator of the locomotive consist; and
operating the first locomotive processor to control the second locomotive controller device.
